(19) United States
(12) Patent Application Publication
(10) Pub. No.: US 2015/0212551 A1
(43) Pub. Date: Jul. 30, 2015

(54) TABLET DEVICE WITH KEYBOARD THAT HAS OVERLAY CAPABILITY

(71) Applicant: Lenovo (Singapore) Pte. Ltd., New Tech Park (SG)

(72) Inventors: ROBERT ADAM PARCHMAN, Fuquay Varina, NC (US); Michaela Rose Case, Raleigh, NC (US)

(73) Assignee: Lenovo (Singapore) Pte. Ltd., New Tech Park (SG)

(21) Appl. No.: 14/163,001

(22) Filed: Jan. 24, 2014

(51) Int. Cl. G06F 1/16

(52) U.S. Cl. CPC G06F 1/1666; G06F 1/1626; G06F 1/1637; G06F 1/1667

(57) ABSTRACT

In one aspect, a multi-panel keyboard computer assembly can be moved between a notebook configuration relative to a tablet computer, in which the main key-bearing panel lies flat in front of the tablet display and the other panels support the display in an erect position, and a tablet footprint configuration, in which the main panel lies flat against the bottom half of the tablet display, with non-virtual keyboard content being moved to the uncovered areas of the display.

### FIELD

The present application relates generally to computer keyboards with multiple configurations.

### BACKGROUND

Computing systems such as tablet computers are often accompanied by key entry devices such as keyboards to usefully augment touch input capability of the computer display. However, such keyboard accessories consume space or otherwise force the tablet into notebook form.

### SUMMARY

Accordingly, a system includes an information handling device having a video display and a processor which controls the display to present demanded images on a display part thereof. A key entry assembly is provided by which a person can enter input to the processor. The key entry assembly includes a main panel bearing input keys, an intermediate panel, and a first joint movably connecting the main and intermediate panels. The key entry assembly is movable to a notebook configuration relative to the display, in which the main panel lies flat in front of the display and the display is supported by the key entry assembly in an erect position. Also, the key entry assembly is movable to a tablet footprint configuration, in which the main panel lies flat against a part of the display, with non-virtual keyboard content being presented on areas of the display not covered by the main panel.

In example embodiments a support panel may be movably connected to the intermediate panel at a second joint. The support panel may bear no keys. Likewise, if desired the intermediate panel bears no keys. At least one of the joints may be a living hinge.

In non-limiting embodiments the main and intermediate panels are parallelepiped-shaped and are rotatably connected to each other at the first joint. If desired, the first joint can extend across substantially an entire edge of the main panel. In example implementations the key entry assembly is movable to a protect configuration, in which the main and intermediate panels cover the display. A non-limiting example of the key entry assembly can lie flat against a bottom surface of a housing bearing the display or against the display.

In another aspect, a device includes a foldable computer key entry assembly for inputting information to a tablet computer having a display. The key entry assembly includes at least two panels, a key-bearing portion of a main panel of which bears key elements. The key entry assembly is movable to a notebook configuration, in which substantially the entire main panel lies flat on a surface in front of the tablet computer and the tablet computer is supported in an orientation tilted from the horizontal. Also, the key entry assembly, to conserve space, can be foldable through an accordion configuration with a Z-shape to a tablet configuration, in which the entire key-bearing portion of the main panel is positioned on the tablet computer such that a footprint of the tablet computer with key entry assembly is substantially the same as a footprint of the tablet computer alone.

In another aspect, a system includes a video display, a processor which controls the display to present demanded images on a display part thereof, and a key entry device by which a person can enter input to the processor. The key entry device has a main panel bearing manipulable input keys, an intermediate panel, and a first joint between the main and intermediate panels. The key entry device has a tablet configuration, in which the main panel lies flat and parallel to the display to partially cover the display, with a part of the display being uncovered when the key entry device is in the tablet configuration. The processor causes non-virtual keyboard content in demanded images to be presented in the part of the display that is uncovered when the key entry device is in the tablet configuration responsive to a determination that contact signals from the display indicate that the key entry device is in the tablet configuration.

The details of embodiments, both as to structure and operation, can best be understood in reference to the accompanying drawings, in which like reference numerals refer to like parts, and in which:

### BRIEF DESCRIPTION OF THE DRAWINGS

FIG. 1 is a block diagram of a system in accordance with present principles;

FIGS. 2-7 are perspective views showing various configurations of the keyboard assembly relative to the tablet computer;

FIG. 8 is a top plan view of the main panel of the keyboard assembly overlaying the bottom half of the tablet display; and

FIG. 9 is a flow chart of example logic.

### DETAILED DESCRIPTION

This disclosure relates generally to consumer electronics (CE) device based and/or workstation based based user information. With respect to any computer systems discussed herein, a system may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

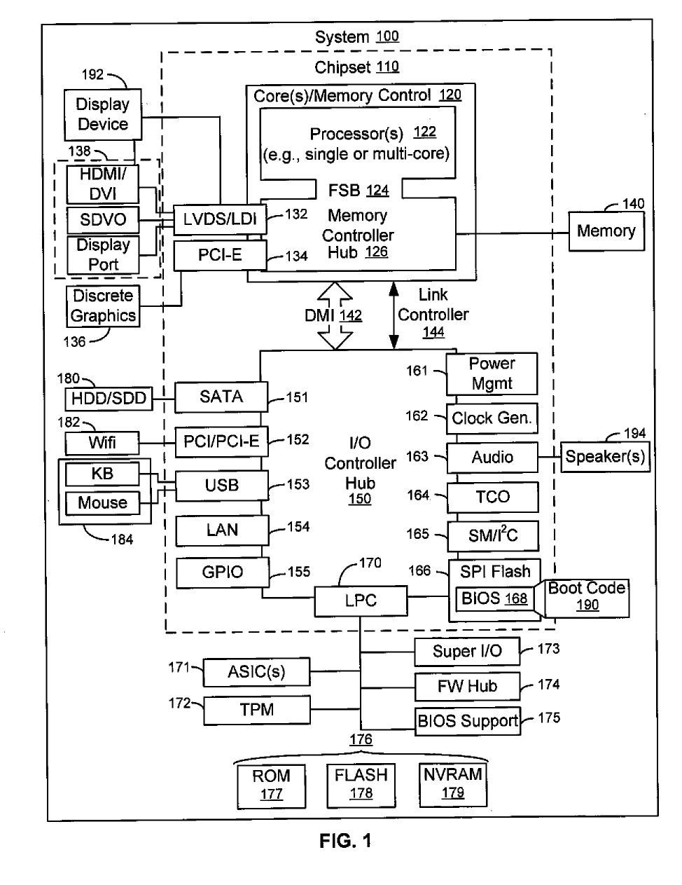

Now in reference to FIG. 1, a block diagram of an illustrative exemplary computer system 100 is shown. The system 100 may include a tablet computer with a single parallelepiped-shaped housing bearing a touchscreen display. The system 100 may alternatively include a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device such as a tablet computer, a server or other machine may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory”.

The memory controller hub 126 further includes a low-voltage differential signaling interface (LVDS) 132. The LVDS 132 may be a so-called LVDS Display Interface (LDI) for support of a video display apparatus 192 (including, e.g., a CRT, a flat panel, a projector, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card. An exemplary system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USE interfaces 153, a LAN interface 154 (more generally a network interface), a general purpose I/O interface (GPIO) 155, a low-pin count (LPC) interface 170, a power management interface 161, a clock generator interface 162, an audio interface 163 (e.g., for speakers 194), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes a basic input output system (BIOS) 168 and boot code 190. As used herein “BIOS” can mean BIOS in the traditional sense and also the newer standard for BIOS/unified extensible firmware interface (UEFI).

With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168. Again, as described herein, an exemplary client device or other machine may include fewer or more features than shown in the system 100 of FIG. 1.

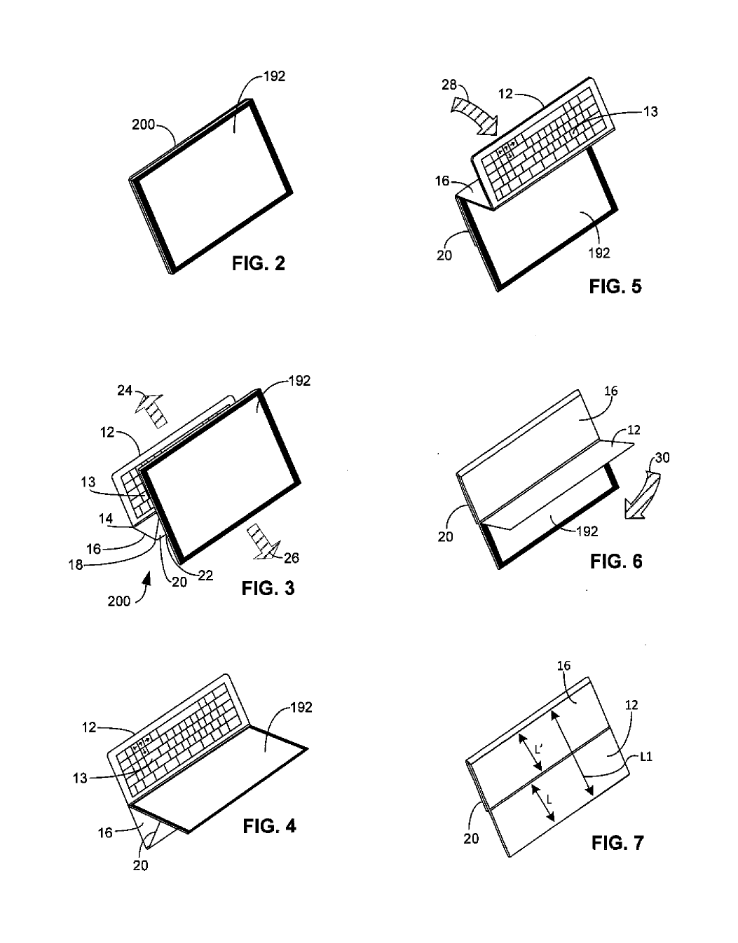

FIGS. 2-7 show an embodiment of the system 100 shown in FIG. 1 configured as a tablet computer in which the display 192 is a touch screen display. A multi-panel keyboard assembly 200 includes a main parallelepiped-shaped panel 12 bearing plural membrane-type or reciprocating-type keys 13, which is rotatably connected via a first hinge joint 14 to a parallelepiped-shaped intermediate panel 16, which may or may not support keys, which in turn is rotatably connected via a second hinge joint 18 to a support panel 20, which typically does not include keys. The support panel 20 may be separate from the tablet computer or it may be slidably and/or rotatably connected to the tablet computer by a third joint 22.

Thus, each panel 12, 16, 20 has a rectangular surface area, although other shapes may be used. In the embodiment shown, only the main panel 12 bears keys 10; the intermediate and support panels bear no keys. The panels 12, 16, 20 may be made of lightweight metal or plastic. The hinges 14, 18 may be, when plastic is used, living hinges. Or, the hinges may be established by mechanical hinges with plural discrete elements such as respective thin rods that extend from and parallel to an end of one panel and that engage plural small partial or complete rings on the facing end of the adjacent panel, in rotatable engagement therewith. Other hinge structure may be used if desired. The joint 22 between the tablet and the support panel 20 may permit slidable as well as rotatable motion therebetween.

The joints 14, 18, 22 may as shown extend across substantially the entire edge of the panel(s) with which they are coupled. The width of the panels of the assembly 200 may be the same as each other and the same as the width of the tablet, or the width of the assembly 200 may be different from the width of the tablet. In example shown, the length “L” (FIG. 7) of the main panel 12 may be about one-half the length L1 of the tablet and the same as the length L′ of the intermediate panel 16.

FIGS. 2 and 7 shows that owing to the rotatable motion about the joints, the keyboard assembly 200 may lie flat and flush against either the bottom of the tablet (FIG. 2) or the top (i.e., display 192 side) of the tablet (FIG. 7) to protect whichever side it lies against. It is to be understood that the support panel 20 in either case may double up, lying flat against the bottom of tablet in FIG. 7 and doubling up against the main panel 12 in FIG. 2.

FIG. 3 shows that the assembly 200 may be unfolded from the configuration shown in FIG. 2 by pulling the main panel 12 forward in the direction of the arrow 24 and sliding the support panel rearwardly along the joint 22 in the direction of the arrow 26. Continued motion in these directions causes pivoting of the panels 12, 16, 20 relative to each other at the joints 14, 18 until the “notebook” configuration of FIG. 4 is established, in which substantially the entire main panel lies flat on a surface in front of the display 192, the display 192 (tablet) is erect, i.e., vertical or near-vertical with a slight rearward tilt, substantially the entire intermediate panel 16 lies flat on the surface behind the tablet opposite the display 192, and the support panel 20 angles obliquely upward from the intermediate panel 16 to the tablet to support the display 192 in the erect position shown. In this configuration, a user can input characters using the keys 13 on the main panel 12.

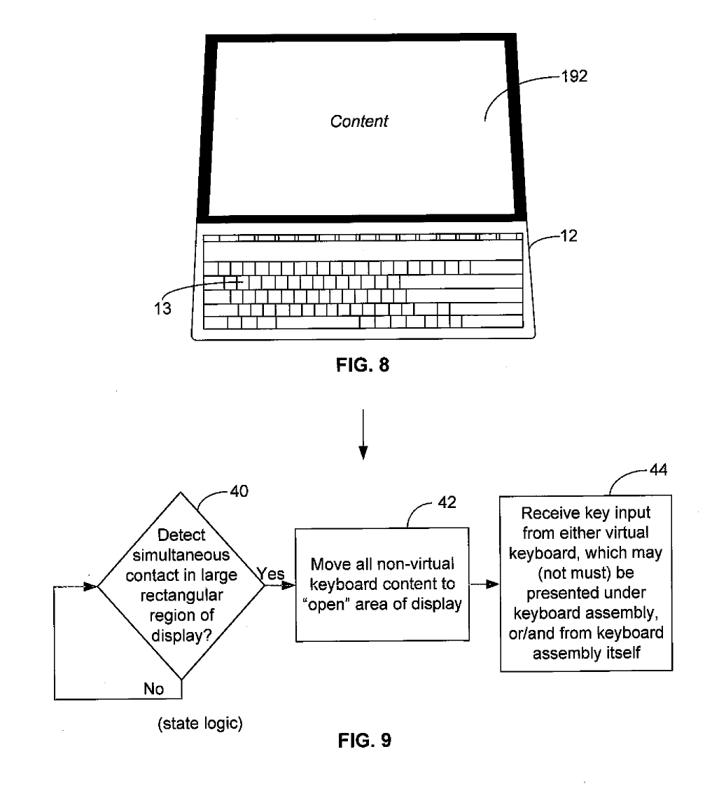

However, to conserve space the keyboard assembly 200 can be folded through an accordion configuration to establish a Z-like shape. The keyboard assembly 200 may be held in the accordion configuration shown by frictional resistance of the hinges, which may be overcome by gentle hand pressure, or by other suitable means. Continued folding motion of the keyboard assembly 200 in the direction shown by the arrow 28 in FIG. 5 results in the intermediate panel lying flat and flush against about half the surface of the display 192 with the main panel 12 lying flat and flush on the intermediate panel 16 as shown in FIG. 8 and discussed further below. The support panel 20 may slide along the tablet accordingly, remaining flat against the bottom surface of the tablet as shown in FIG. 5. In this “keyboard entry, tablet footprint” configuration, the “footprint” of the combined tablet/keyboard assembly 200 is substantially the same as the footprint of the tablet alone, yet instead of having to use a virtual keyboard presented on the display 192, the user may affect key entry using the more convenient keys 13 on the main panel 12 of the keyboard assembly 200. FIG. 6, arrow 30 illustrates that the main panel 12 may be folded 180 degrees from the keyboard entry, tablet footprint configuration to the display protection configuration in FIG. 7, in which the main and intermediate panels 12, 16 cover substantially all of the display 192 to protect it, lying flat against the display 192.

FIG. 8 shows the main panel 12 lying against the display 192 leaving an uncovered portion of the display 192 in which content is shown. In this configuration the intermediate and support panels may be “accordioned” between the main panel 12 and the display or one or both of the panels 16, 20 may be double backed around the bottom of the edge of the display to lie against the bottom side of the tablet, opposite the display. If desired, all non-virtual keyboard content of demanded images can be entirely presented in the uncovered area, re-sized and/or re-configured as necessary. In effect, the tablet processor can establish or otherwise model a virtual keyboard on the portion of the display 192 under the main panel 12 as it would conventionally when only a virtual keyboard is provided, moving non-virtual content to uncovered areas of the display. A virtual keyboard need not actually be rendered on the display 192 underneath the main panel 12 or it may, but in either case the processor can assume in example implementations that the covered portion of the display has been allocated to key entry purposes and accordingly moves other content to the uncovered areas of the display without requiring excessive software changes apart from those implicated herein, e.g., in FIG. 9.

FIG. 9 illustrates in flow chart form what may be implemented in some examples by state logic, in which, at state 40, the touch screen display senses simultaneous contact on it in a large rectilinear pattern (as indicated by, e.g., pattern recognition based on sensed contact points on the display), indicating that the main panel 12 has been folded into the tablet configuration shown in FIG. 8. When this occurs, logic flows to block 42 to move (if necessary) preferably all non-virtual keyboard content of demanded images to the uncovered portion of the display as discussed above. Note that the “uncovered” portion of the display may be regarded by the tablet processor as that portion lying outside the perimeter of the sensed contacts. At block 44 key input is received either from the main panel 12 of the keyboard assembly 200 or, when a virtual keyboard is presented on the display under the main panel 12 and the main panel 12 lifted far enough away from the display to permit a user to touch the virtual keyboard, from the virtual keyboard.

Without reference to any particular figure, it is to be understood that present principles are e.g. directed to a key entry device that can be placed on the top of a tablet display. E.g., the display can be a touch screen display and when a large object such as the key entry device is detected to be positioned on the tablet display, the tablet may invoke an onscreen virtual keyboard that is presented beneath the key entry device with the tablet adjusting the positioning of other content around the (covered) onscreen virtual keyboard.

Also without reference to any particular figure, it is to be understood that a keyboard in accordance with present principles may be membrane-type keyboard and/or a keyboard in a more traditional sense.

While the particular TABLET DEVICE WITH KEYBOARD THAT HAS OVERLAY CAPABILITY is herein shown and described in detail, it is to be understood that the subject matter which is encompassed by the present disclosure is limited only by the claims.

What is claimed is:

1. A system, comprising:
an information handling device having a video display;
a processor which controls the display to present demanded images on a display part thereof; and
a key entry assembly by which a person can enter input to the processor, the key entry assembly comprising:
a main panel bearing input keys;
an intermediate panel;
a first joint movably connecting the main and intermediate panels;
wherein the key entry assembly is movable to a notebook configuration relative to the display, in which the main panel lies flat in front of the display and the display is supported by the key entry assembly in an erect position, and the key entry assembly is movable to a tablet footprint configuration, in which the main panel lies flat against a part of the display, with non-virtual keyboard content being presented on areas of the display not covered by the main panel.

2. The system of claim 1, comprising a support panel movably connected to the intermediate panel at a second joint, wherein the main panel bears plural keys and the support panel bears no keys.

3. The system of claim 1, wherein the intermediate panel bears no keys.

4. The system of claim 1, wherein at least one joint is a living hinge.

5. The system of claim 1, wherein the main and intermediate panels are parallelepiped-shaped and are rotatably connected to each other at the first joint.

6. The system of claim 1, wherein the first joint extends across substantially an entire edge of the main panel.

7. The system of claim 1, wherein the key entry assembly is movable to a protect configuration, in which the main and intermediate panels cover the display.

8. The system of claim 1, wherein the key entry assembly can lie flat against a bottom surface of a housing bearing the display and against the display.

9. Device comprising:
a foldable computer key entry assembly for inputting information to a tablet computer, the key entry assembly including at least two panels, a key-bearing portion of a main panel of which bears key elements, the key entry assembly being movable to a notebook configuration, in which substantially the entire main panel lies flat on a surface in front of the tablet computer and the tablet computer is supported in an orientation tilted from the horizontal, the key entry assembly being foldable through an accordion configuration with a Z-shape to a tablet configuration, in which the entire key-bearing portion of the main panel is positioned on the tablet computer such that a footprint of the tablet computer with key entry assembly is substantially the same as a footprint of the tablet computer alone.

10. The device of claim 9, wherein when the key entry assembly is in the tablet configuration, key entry is affected on the main panel of the key entry assembly instead of a virtual keyboard presented on the tablet computer.

11. The device of claim 9, wherein the key entry assembly is movable to a display protection configuration in which the main and intermediate panels cover all of the tablet computer.

12. The device of claim 9, comprising a support panel movably connected to the intermediate panel at a joint, wherein the main panel bears plural keys and the support panel bears no keys.

13. The device of claim 9, wherein the intermediate panel bears no keys.

14. The device of claim 12, wherein the joint is a living hinge.

15. The device of claim 9, wherein the main and intermediate panels are parallelepiped-shaped and are rotatably connected to each other at a first joint.

16. The device of claim 15, wherein the first joint extends across substantially an entire edge of the main panel.

17. A system, comprising:
a video display;
a processor which controls the display to present demanded images on a display part thereof; and
a key entry device by which a person can enter input to the processor, the key entry device comprising:
a main panel bearing manipulable input keys;
an intermediate panel;
a first joint between the main and intermediate panels;
wherein the key entry device has a tablet configuration, in which the main panel lies flat and parallel to the display to partially cover the display, a part of the display being uncovered when the key entry device is in the tablet configuration, the processor causing non-virtual keyboard content in demanded images to be presented in the part of the display that is uncovered when the key entry device is in the tablet configuration responsive to a determination that contact signals from the display indicate that the key entry device is in the tablet configuration.

18. The system of claim 17, wherein the key entry device is movable to a notebook configuration, in which substantially the entire main panel lies flat on a surface in front of the display and the display is supported in an orientation tilted from the horizontal.

19. The system of claim 17, wherein the key entry device is movable to a display protection configuration in which the main and intermediate panels cover all of the display.

20. The system of claim 17, comprising a support panel movably connected to the intermediate panel at a joint, wherein the main panel bears plural keys and the support panel bears no keys.
